(19) United States
(12) Patent Application Publication
(10) Pub. No.: US 2010/0214204 A1
(43) Pub. Date: Aug. 26, 2010

(54) LCD WITH COMMON VOLTAGE DRIVING CIRCUITS

(75) Inventors: Kuohao Fanchiang, Hsinchu (TW); Kung-Yi Chan, Hsinchu (TW); Huan-Hsin Li, Hsinchu (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: AU Optronics Corporation, Hsinchu (TW)

(21) Appl. No.: 12/392,796

(22) Filed: Feb. 25, 2009

(51) Int. Cl. G09G 3/36

(52) U.S. Cl. 345/94

(57) ABSTRACT

An LCD with power consumption reduction and a method of driving the same. In one embodiment, the LCD has a plurality of pixels spatially arranged in the form of a matrix having N pixel rows, each pixel row defined between two neighboring scanning lines Gₙ and Gₙ₊₁, and having an auxiliary common electrode, and a plurality of common voltage driving circuits, each common voltage driving circuit electrically coupled between the scanning line Gₙ and the corresponding auxiliary common electrode for providing a two-level lift-up coupling voltage to the auxiliary common electrode.

### FIELD OF THE INVENTION

The present invention relates generally to a liquid crystal display (LCD), and more particularly, to an LCD that utilizes a two level lift-up coupling voltage scheme to achieve the row inversion and reduce power consumption and methods of driving same.

### BACKGROUND OF THE INVENTION

A liquid crystal display (LCD) device includes an LCD panel formed with liquid crystal cells and pixel elements with each associating with a corresponding liquid crystal cell and having a liquid crystal (LC) capacitor and a storage capacitor, a thin film transistor (TFT) electrically coupled with the liquid crystal capacitor and the storage capacitor. These pixel elements are substantially arranged in the form of a matrix having a number of pixel rows and a number of pixel columns. Typically, scanning signals are sequentially applied to the number of pixel rows for sequentially turning on the pixel elements row-by-row. When a scanning signal is applied to a pixel row to turn on corresponding TFTs of the pixel elements of a pixel row, source signals (i.e., image signals) for the pixel row are simultaneously applied to the number of pixel columns so as to charge the corresponding liquid crystal capacitor and storage capacitor of the pixel row for aligning orientations of the corresponding liquid crystal cells associated with the pixel row to control light transmittance therethrough. By repeating the procedure for all pixel rows, all pixel elements are supplied with corresponding source signals of the image signal, thereby displaying the image signal thereon.

Liquid crystal molecules have a definite orientational alignment as a result of their long, thin shapes. The orientations of liquid crystal molecules in liquid crystal cells of an LCD panel play a crucial role in the transmittance of light therethrough. It is known if a substantially high voltage potential is applied between the liquid crystal layer for a long period of time, the optical transmission characteristics of the liquid crystal molecules may change. This change may be permanent, causing an irreversible degradation in the display quality of the LCD panel. In order to prevent the LC molecules from being deteriorated, an LCD device is usually driven by using techniques that alternate the polarity of the voltages applied across a LC cell. These techniques may include inversion schemes such as frame inversion, row inversion, column inversion, and dot inversion. Typically, notwithstanding the inversion schemes, a higher image quality requires higher power consumption because of frequent polarity conversions. For example, the conventional design with row inversion lost much more power consumption. For the conventional DC Vcom solution, it needs higher data voltage to be column inversion.

Therefore, a heretofore unaddressed need exists in the art to address the aforementioned deficiencies and inadequacies.

### SUMMARY OF THE INVENTION

The present invention, in one aspect, relates to an LCD with color washout improvement. In one embodiment, the LCD includes a common electrode, a plurality of scanning lines, {Gₙ}, n=1, 2, . . . , N, N being an integer greater than zero, spatially arranged along a row direction, a plurality of data lines, {Dₘ}, m=1, 2, . . . , M, M being an integer greater than zero, spatially arranged crossing the plurality of scanning lines {Gₙ} along a column direction perpendicular to the row direction, and a plurality of pixels, {P_{n,m}}, spatially arranged in the form of a matrix. Each pixel row is defined between two neighboring scanning lines Gₙ and Gₙ₊₁ and has an auxiliary common electrode ACE. Each pixel P_{n,m} is defined between two neighboring scanning lines Gₙ and Gₙ₊₁ and two neighboring data lines Dₘ and Dₘ₊₁ and comprises a pixel electrode, a transistor, T0, having a gate, a source and a drain electrically coupled to the scanning line Gₙ, the data line Dₘ and the pixel electrode, respectively, a liquid crystal capacitor, Clc, electrically coupled between the pixel electrode and the common electrode, and a charge storage capacitor, Cst, electrically coupled between the pixel electrode and the auxiliary common electrode ACEₙ.

The LCD also includes a plurality of common voltage driving circuits {CTₙ} Each common voltage driving circuit CTₙ is electrically coupled between the scanning line Gₙ and the corresponding auxiliary common electrode ACEₙ and comprises a first transistor, T1, having a gate electrically coupled to the scanning line Gₙ, a source configured to receive a first voltage, VDC, and a drain electrically coupled to the auxiliary common electrode ACEₙ, a second transistor, T2, having a gate electrically coupled to the scanning line Gₙ, a source configured to receive a second voltage, VDC1ₙ, and a drain, a third transistor, T3, having a gate electrically coupled to the scanning line Gₙ, a source configured to receive a third voltage, VDC2ₙ, and a drain, a fourth transistor, T4, having a gate configured to receive a fourth voltage, SWCₙ, a source electrically coupled to the drain of the third transistor T3, and a drain electrically coupled to the drain of the second transistor T2, a first capacitor, C1, having a first terminal electrically coupled to the drain of the first transistor T1 and a second terminal electrically coupled to the drain of the second transistor T2, and a second capacitor, C2, having a first terminal electrically coupled to the drain of the third transistor T3 and a second terminal configured to receive a fifth voltage, VACₙ.

In one embodiment, each of the first voltage VDC, the second voltage VDC1ₙ and the third voltage VDC2ₙ is a DC voltage, and wherein each of the fourth voltage SWCₙ and the fifth voltage VACₙ is an AC voltage. In one embodiment, VDC1ₙ=VDC2ₙ₊₁, and VDC2ₙ=VDC1ₙ₊₁, and wherein the fourth voltage SWCₙ is characterized a waveform that is complimentary to the waveform of a corresponding gate signal gₙ.

The LCD further comprises a panel having an active area for display and a non-active area adjacent to the active area, wherein the plurality of pixels, {P_{n,m}} is formed in the active area of the panel, and wherein the plurality of common voltage driving circuits {CTₙ} is formed in the non-active area of the panel.

The LCD also comprises a gate driver for generating a plurality of scanning signals respectively applied to the plurality of scanning lines {Gₙ}, wherein the plurality of scanning signals is configured to turn on the transistors connected to the plurality of scanning lines {Gₙ} in a predefined sequence, and a data driver for generating a plurality of data signals respectively applied to the plurality of data lines {Dₘ}.

In one embodiment, each of the plurality of scanning signals is configured to have a waveform having a first voltage potential, V_{GH}, and a second voltage potential, V_{GL}, wherein V_{GH}>V_{GL}, and wherein the waveform of each of the scanning signals is sequentially shifted from one another.

In another aspect, the present invention relates to an LCD. The LCD has a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, and comprises a common electrode, a plurality of pixels, {P_{n,m}}, spatially arranged in the form of a matrix having N pixel rows and M pixel columns. Each pixel row is defined between two neighboring scanning lines Gₙ and Gₙ₊₁ and has an auxiliary common electrode ACEₙ. Each pixel P_{n,m} is defined between two neighboring scanning lines Gₙ and Gₙ₊₁ and two neighboring data lines Dₘ and Dₘ₊₁ and comprises a pixel electrode, a transistor, T0, having a gate, a source and a drain electrically coupled to the scanning line Gₙ, the data line Dₘ and the pixel electrode, respectively, a liquid crystal capacitor, Clc, electrically coupled between the pixel electrode and the common electrode, and a charge storage capacitor, Cst, electrically coupled between the pixel electrode and the auxiliary common electrode ACEₙ.

Furthermore, the LCD includes a plurality of common voltage driving circuits {CTₙ}, each common voltage driving circuit CTₙ, electrically coupled between the scanning line Gₙ and the corresponding auxiliary common electrode ACEₙ for providing a two-level lift-up coupling voltage to the auxiliary common electrode ACEₙ. In one embodiment, each common voltage driving circuit CTₙ comprises a first transistor, T1, having a gate electrically coupled to the scanning line Gₙ, a source configured to receive a first voltage, VDC, and a drain electrically coupled to the auxiliary common electrode ACEₙ, a second transistor, T2, having a gate electrically coupled to the scanning line Gₙ, a source configured to receive a second voltage, VDC1ₙ, and a drain, a third transistor, T3, having a gate electrically coupled to the scanning line Gₙ, a source configured to receive a third voltage, VDC2ₙ, and a drain, a fourth transistor, T4, having a gate configured to receive a fourth voltage, SWCₙ, a source electrically coupled to the drain of the third transistor T3, and a drain electrically coupled to the drain of the second transistor T2, a first capacitor, C1, having a first terminal electrically coupled to the drain of the first transistor T1 and a second terminal electrically coupled to the drain of the second transistor T2, and a second capacitor, C2, having a first terminal electrically coupled to the drain of the third transistor T3 and a second terminal configured to receive a fifth voltage, VACₙ. Each of the first voltage VDC, the second voltage VDC1ₙ and the third voltage VDC2ₙ is a DC voltage, and wherein each of the fourth voltage SWCₙ and the fifth voltage VACₙ is an AC voltage.

Additionally, the LCD also includes a gate driver for generating a plurality of scanning signals respectively applied to the plurality of scanning lines {Gₙ}, wherein the plurality of scanning signals is configured to turn on the transistors connected to the plurality of scanning lines {Gₙ} in a predefined sequence, and a data driver for generating a plurality of data signals respectively applied to the plurality of data lines {Dₘ}. In one embodiment, each of the plurality of scanning signals is configured to have a waveform having a first voltage potential, V_{GH}, and a second voltage potential, V_{GL}, wherein V_{GH}>V_{GL}, and wherein the waveform of each of the scanning signals is sequentially shifted from one another.

The LCD further comprises a panel having an active area for display and a non-active area adjacent to the active area, wherein the plurality of pixels, {P_{n,m}} is formed in the active area of the panel, and wherein the plurality of common voltage driving circuits {CTₙ} is formed in the non-active area of the panel.

In yet another aspect, the present invention relates to a method of driving a liquid crystal display (LCD) having a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, and a plurality of pixels, {P_{n,m}}, spatially arranged in the form of a matrix having N pixel rows and M pixel columns, each pixel row, defined between two neighboring scanning lines Gₙ and Gₙ₊₁, having an auxiliary common electrode ACEₙ, each pixel P_{n,m}, defined between two neighboring scanning lines Gₙ and Gₙ₊₁ and two neighboring data lines Dₘ and Dₘ₊₁, comprising a pixel electrode, a common electrode, a transistor, T0, having a gate, a source and a drain electrically coupled to the scanning line Gₙ, the data line Dₘ and the pixel electrode, respectively, a liquid crystal capacitor, Clc, electrically coupled between the pixel electrode and the common electrode, and a charge storage capacitor, Cst, electrically coupled between the pixel electrode and the auxiliary common electrode ACEₙ.

In one embodiment, the method includes the steps of providing a plurality of common voltage driving circuits {CTₙ}, each common voltage driving circuit CTₙ, electrically coupled between the scanning line Gₙ and the corresponding auxiliary common electrode ACEₙ, applying a plurality of scanning signals to the plurality of scanning lines {Gₙ} and a plurality of data signals to the plurality of data lines {Dₘ} respectively, the plurality of scanning signals configured to turn on the switching elements connected to the plurality of scanning lines {Gₙ} in a predefined sequence, and applying a plurality of common voltage driving signals to the plurality of common voltage driving circuits {CTₙ} so as to responsively generate a plurality of two-level lift-up coupling voltages, each two-level lift-up coupling voltage applied to the auxiliary common electrode ACEₙ, of a corresponding pixel row. Each common voltage driving signal includes a set of a first voltage VDC, a second voltage VDC1ₙ, a third voltage VDC2ₙ, a fourth voltage SWCₙ, and a fifth voltage VACₙ.

In one embodiment, each common voltage driving circuit comprises a first transistor, T1, having a gate electrically coupled to the scanning line Gₙ, a source configured to receive the first voltage VDC, and a drain electrically coupled to the auxiliary common electrode ACEₙ, a second transistor, T2, having a gate electrically coupled to the scanning line Gₙ, a source configured to receive the second voltage VDC1ₙ, and a drain, a third transistor, T3, having a gate electrically coupled to the scanning line Gₙ, a source configured to receive the third voltage VDC2ₙ, and a drain, a fourth transistor, T4, having a gate configured to receive the fourth voltage, SWCₙ, a source electrically coupled to the drain of the third transistor T3, and a drain electrically coupled to the drain of the second transistor T2, a first capacitor, C1, having a first terminal electrically coupled to the drain of the first transistor T1 and a second terminal electrically coupled to the drain of the second transistor T2, and a second capacitor, C2, having a first terminal electrically coupled to the drain of the third transistor T3 and a second terminal configured to receive the fifth voltage, VACₙ. Each of the first voltage VDC, the second voltage VDC1ₙ and the third voltage VDC2ₙ is a DC voltage, and wherein each of the fourth voltage SWCₙ and the fifth voltage VACₙ is an AC voltage. In operation, the plurality of pixels {P_{n,m}} has a pixel polarity that is in the row inversion.

In a further aspect, the present invention relates to a common voltage driving circuit for a liquid crystal display (LCD) having a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, and a plurality of pixels, {P_{n,m}}, spatially arranged in the form of a matrix having N pixel rows and M pixel columns, each pixel row, defined between two neighboring scanning lines Gₙ and Gₙ₊₁, having an auxiliary common electrode ACEₙ.

In one embodiment, the common voltage driving circuit comprises a first transistor, T1, having a gate electrically coupled to the scanning line Gₙ, a source configured to receive the first voltage VDC, and a drain electrically coupled to the auxiliary common electrode ACEₙ, a second transistor, T2, having a gate electrically coupled to the scanning line Gₙ, a source configured to receive the second voltage VDC1ₙ, and a drain, a third transistor, T3, having a gate electrically coupled to the scanning line Gₙ, a source configured to receive the third voltage VDC2ₙ, and a drain, a fourth transistor, T4, having a gate configured to receive the fourth voltage, SWCₙ, a source electrically coupled to the drain of the third transistor T3, and a drain electrically coupled to the drain of the second transistor T2, a first capacitor, C1, having a first terminal electrically coupled to the drain of the first transistor T1 and a second terminal electrically coupled to the drain of the second transistor T2, and a second capacitor, C2, having a first terminal electrically coupled to the drain of the third transistor T3 and a second terminal configured to receive the fifth voltage, VACₙ. Each of the first voltage VDC, the second voltage VDC1ₙ and the third voltage VDC2ₙ is a DC voltage, and wherein each of the fourth voltage SWCₙ and the fifth voltage VACₙ is an AC voltage.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, wherein:

FIG. 1 shows schematically a partially circuit diagram of an LCD according to one embodiment of the present invention;

FIG. 2 shows time charts of driving signals applied to the LCD and corresponding pixel voltage potentials in the LCD according to one embodiment of the present invention;

FIG. 3 shows time charts of driving signals applied to the LCD and corresponding pixel voltage potentials in the LCD according to another embodiment of the present invention;

FIG. 4 shows an HSpice simulation for a TMD Vcom row inversion on a 6×8 pixel matrix of an LCD; and

FIG. 5 shows an HSpice simulation for a two level lift-up row inversion on a 6×8 pixel matrix of an LCD according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Additionally, some terms used in this specification are more specifically defined below.

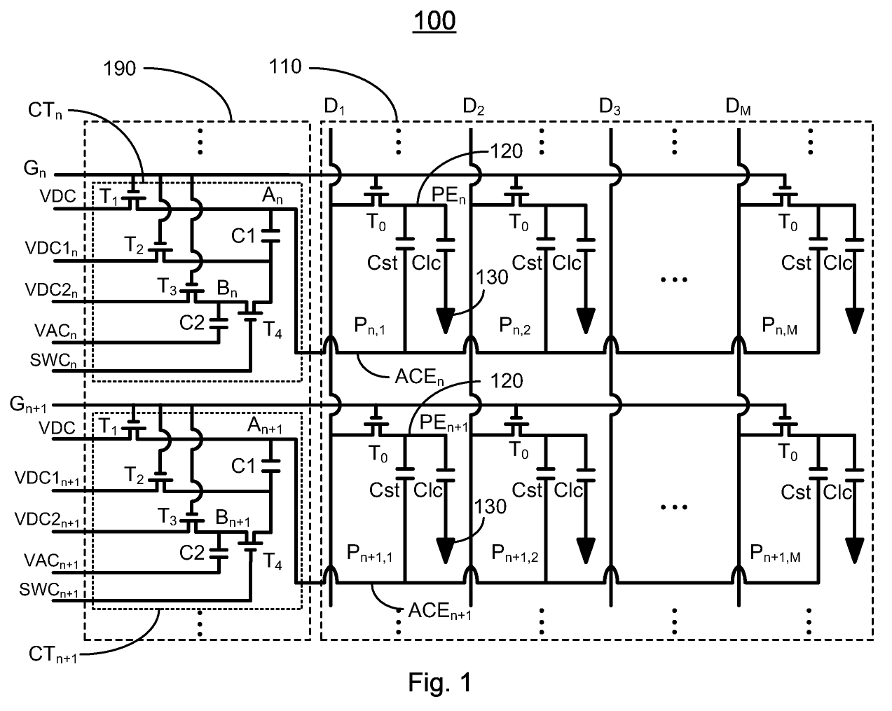

The description will be made as to the embodiments of the present invention in conjunction with the accompanying drawings in FIGS. 1-5. In accordance with the purposes of this invention, as embodied and broadly described herein, this invention, in one aspect, relates to an LCD that utilizes a two-level lift-up coupling voltage driving scheme to achieve the row inversion and a method of driving same. The use of the two-level lift-up coupling voltage mechanism is able to reduce the swing frequency of the common voltage driver, and avoid larger voltage outputs from the source driver, thereby, reducing the power consumption of the common voltage and source drivers.

Referring to FIG. 1, an LCD panel 100 according to one embodiment of the present invention is partially and schematically shown. The LCD panel 100 includes a common electrode 130, a plurality of scanning lines, G₁, G₂, . . . , Gₙ, Gₙ₊₁, . . . , Gₙ, that are spatially arranged along a row (scanning) direction, and a plurality of data lines, D₁, D₂, . . . , Dₘ, Dₘ₊₁, . . . , D_{M}, that are spatially arranged crossing the plurality of scanning lines G₁, G₂, . . . , Gₙ, Gₙ₊₁, . . . , G_{N} along a column direction that is perpendicular to the row direction 130. N and M are integers greater than one. The LCD panel 100 further has a plurality of pixels, {P_{n,m}}, that is spatially arranged in the form of a matrix. Each pixel row is defined between two neighboring scanning lines Gₙ and Gₙ₊₁ and has an auxiliary common electrode ACEₙ. Each pixel P_{n,m} is defined between two neighboring scanning lines Gₙ and Gₙ₊₁ and two neighboring data lines Dₘ and Dₘ₊₁. For the purpose of illustration of embodiments of the present invention, FIG. 1 schematically shows only two scanning lines Gₙ, Gₙ₊₁, four data lines D₁, D₂, D₃ and D_{M}, and six corresponding pixels, P_{n,1}, P_{n,2}, P_{n,M}, P_{n+1,1}, P_{n+1,2}, and P_{n+1,M}, of the LCD panel 100.

Each pixel P_{n,m} has a pixel electrode 120, a transistor, T0, having a gate, a source and a drain electrically coupled to the scanning line Gₙ, the data line Dₘ and the pixel electrode 120, respectively, a liquid crystal capacitor, Clc, electrically coupled between the pixel electrode 120 and the common electrode 130, and a charge storage capacitor, Cst, electrically coupled between the pixel electrode 120 and the auxiliary common electrode ACEₙ. In one embodiment, the auxiliary common electrode ACEₙ may be formed individually for each pixel, and the individually formed auxiliary common electrodes in such a pixel row are electrically connected to one another.

The LCD 100 further includes a gate driver and a data driver (not shown). The gate driver is adapted for generating a plurality of scanning signals, {gₙ}, respectively applied to the plurality of scanning lines {Gₙ}. The plurality of scanning signals {gₙ} is configured to turn on the transistors connected to the plurality of scanning lines {Gₙ} in a predefined sequence. The data driver is adapted for generating a plurality of data signals, {dₙ}, respectively applied to the plurality of data lines {Dₘ}.

In one embodiment, each of the plurality of scanning signals {gₙ} is configured to have a waveform having a first voltage potential, V_{GH}, and a second voltage potential, V_{GL}, where V_{GH}>V_{GL}. The waveform of each scanning signal gₙ, is sequentially shifted from one another.

The LCD 100 also includes a plurality of common voltage driving circuits {CTₙ} Each common voltage driving circuit CTₙ is electrically coupled between the scanning line Gₙ and the corresponding auxiliary common electrode ACEₙ and includes a first transistor, T1, a second transistor, T2, a third transistor, T3, a fourth transistor, T4, a first capacitor, C1, and a second capacitor, C2.

The first transistor T1 has a gate electrically coupled to the scanning line Gₙ, a source configured to receive a first voltage, VDC, and a drain electrically coupled to the auxiliary common electrode ACEₙ. The second transistor T2 has a gate electrically coupled to the scanning line Gₙ, a source configured to receive a second voltage, VDC1ₙ, and a drain. The third transistor T3 has a gate electrically coupled to the scanning line Gₙ, a source configured to receive a third voltage, VDC2ₙ, and a drain. The fourth transistor T4 has a gate configured to receive a fourth voltage, SWCₙ, a source electrically coupled to the drain of the third transistor T3, and a drain electrically coupled to the drain of the second transistor T2. The first capacitor C1 has a first terminal electrically coupled to the drain of the first transistor T1 and a second terminal electrically coupled to the drain of the second transistor T2. The second capacitor C2 has a first terminal electrically coupled to the drain of the third transistor T3 and a second terminal configured to receive a fifth voltage, VACₙ.

Each of the first voltage VDC, the second voltage VDC1ₙ and the third voltage VDC2ₙ is a DC voltage. In one embodiment, VDC1ₙ=VDC2ₙ₊₁, and VDC2ₙ=VDC1ₙ₊₁.

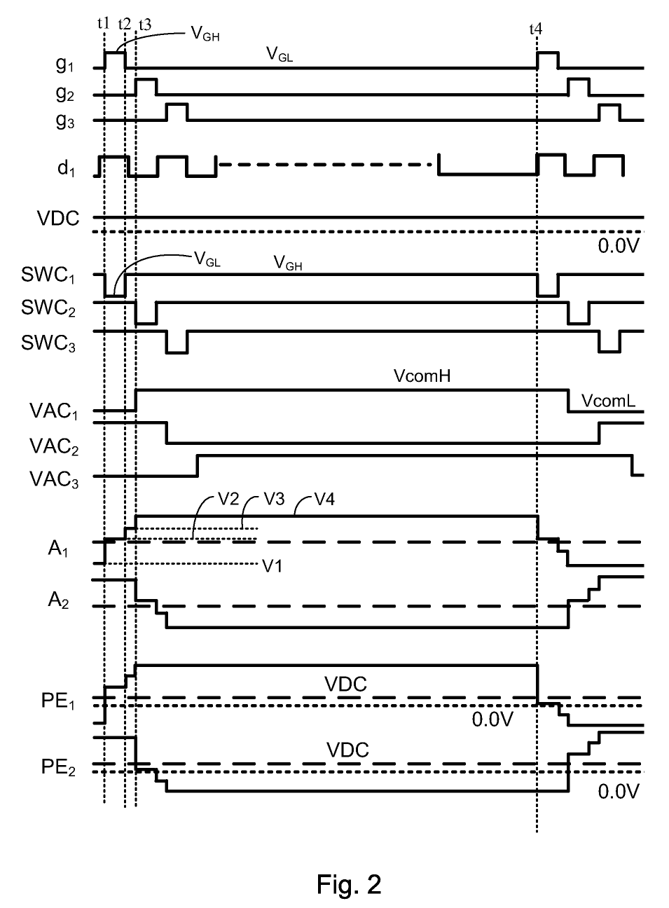

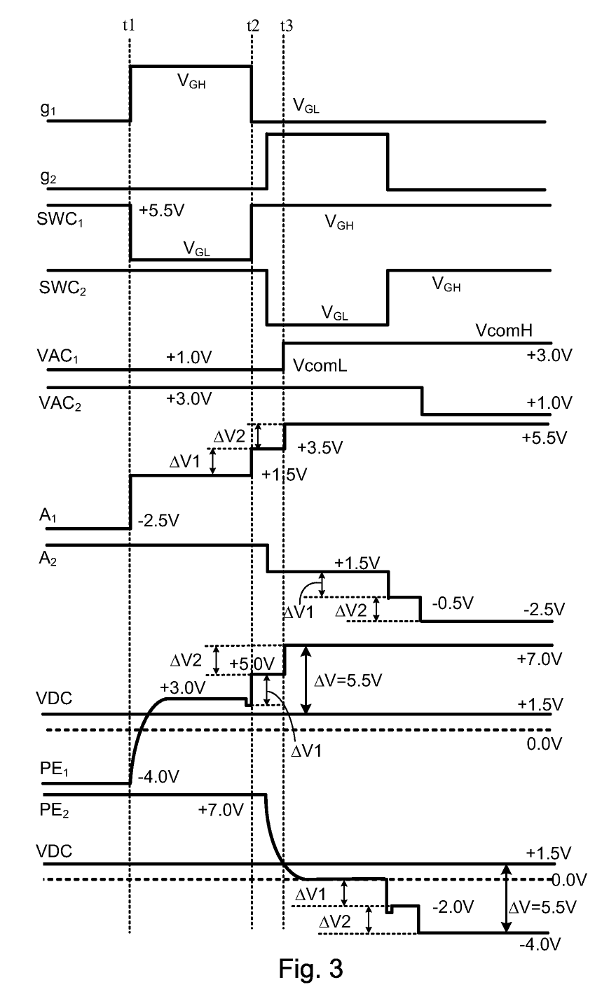

Additionally, each of the fourth voltage SWCₙ and the fifth voltage VACₙ is an AC voltage and characterized with a waveform having a high voltage potential and a low voltage potential. For example, the waveform of the fourth voltage SWCₙ has a high voltage potential, V_{GH}, and a low voltage potential, V_{GL}. The waveform of each fourth voltage SWCₙ is sequentially shifted from one another. In one embodiment, the waveform of the fourth voltage SWCₙ is configured to be complimentary to the waveform of a corresponding scanning signal gₙ, i.e., when the fourth voltage SWCₙ is in its voltage potential, V_{GH}, the corresponding scanning signal gₙ is in the low potential V_{GL}, and vice versus. Further, the waveform of the fifth voltage VACₙ has a high voltage potential, VcomH, and a low voltage potential, VcomL. The waveform of each fifth voltage VACₙ is also sequentially shifted from one another. The time charts of the fourth voltage SWCₙ and the fifth voltage VACₙ are shown in FIGS. 2 and 3.

For such an arrangement, in operation, the DC voltage signals of the first voltage VDC, the second voltage VDC1ₙ, and the third voltage VDC2ₙ are coupled to the AC voltage signal of the fourth voltage VACₙ, which is charged to the charge storage capacitors Cst of the corresponding pixel row, thereby reducing driving voltages, i.e., the data signals {dₘ}, applied to the data lines {Dₘ}.

According to the present invention, the plurality of pixels, {P_{n,m}} is formed in an active area 110 of a panel of the LCD, which is an area for display of images, and the plurality of common voltage driving circuits {CTₙ} is formed in a non-active area 190 of the panel. The non-active area 190 is adjacent to the active area 110. The panel usually formed to have a multilayer structure, which is known to people skilled in the art.

FIG. 2 shows exemplary time charts of driving signals applied to the LCD and corresponding pixel voltage potentials in the LCD according to one embodiment of the present invention. In the charts, g₁, g₂ and g₃ are the scanning signals applied to the scanning lines (gates) G₁, G₂ and G₃, respectively. Each of the scanning signals g₁, g₂ and g₃ is characterized with a waveform having a high voltage potential V_{GH} for a duration of T and a low voltage potential V_{GL} for other duration in one frame. In the embodiment, T=(t2−t1), the frame is t4−t1. The waveforms of the scanning signals g₁, g₂ and g₃ are sequentially shifted for one frame. d₁ is the data signal applied to the data line D₁.

VDC is the first voltage signal applied to the source of the first transistor T1 of each common voltage driving circuit. SWC₁, SWC₂ and SWC₃ are the fourth voltage signals applied to the gate of the fourth transistor T4 of the first common voltage driving circuit CT₁, the second common voltage driving circuit CT₂ and the third common voltage driving circuit CT₃, respectively. Each of the fourth voltage signals SWC₁, SWC₂ and SWC₃ is characterized with a waveform having a high voltage potential V_{GH} and a low voltage potential V_{GL} for a duration of T, which is complimentary to the waveform of the corresponding scanning signals g₁, g₂ or g₃. VAC₁, VAC₂ and VAC₃ are the fifth voltage signals applied to the second terminal of the second capacitor C2 of the first common voltage driving circuit CT₁, the second common voltage driving circuit CT₂ and the third common voltage driving circuit CT₃, respectively. Each of the fifth voltage signals VAC₁, VAC₂ and VAC₃ is characterized with a waveform having a high voltage potential VcomH and a low voltage potential VcomL. The waveforms of the fifth voltage signals VAC₁, VAC₂ and VAC₃ are sequentially shifted in one frame.

A₁ and A₂ are the coupling voltage potentials generated by the first common voltage driving circuit CT₁ and the second common voltage driving circuit CT₂ in response to the first set of the first, second, third, fourth and fifth voltage signals VDC, VDC1₁, VDC2₁, VAC₁ and SWC₁, and the second set of the first, second, third, fourth and fifth voltage signals and VDC, VDC1₂, VDC2₂, VAC₂ and SWC₂, respectively. The coupling voltage potentials A₁ and A₂ are applied to the auxiliary common electrodes ACE₁ and ACE₂, thereby charging the storage capacitors Cst of each pixel of the first and second pixel rows, respectively. PE₁ and PE₂ are the corresponding voltage potentials generated at each pixel electrode of the first and second pixel rows, respectively. PE₁ and PE₂ are proportional to A₁ and A₂, respectively. As an example, A₁ is described in details as follows.

As shown in FIG. 2, at time t1, the first gate signal g₁ experiences a change from the low voltage potential V_{GL} to the high voltage potential V_{GH}, while the fourth voltage signals SWCₙ experiences a reversed change, i.e., from the high voltage potential V_{GH} to the low voltage potential V_{GL}.

In the duration from time t1 to t2, the first, second and third transistors T1, T2 and T3 are turned on and the fourth transistor T4 is turned off. Accordingly, the DC voltage potentials of the first and second voltage signals VDC and VDC1₁ are applied to charge the first capacitor C1, and the DC voltage potential of the third voltage signals VDC2₁ and the AC voltage potential of the fifth voltage signal VAC₁ are applied to charge the second capacitor C2. Thus, V2 is associated with only the DC voltage potentials of the first and second voltage signals VDC and VDC1₁.

At time t2, the first gate signal g₁ experiences a change from the high voltage potential V_{GH} to the low voltage potential V_{GL}, while the fourth voltage signals SWC₁ experiences a reversed change, i.e., from the low voltage potential V_{GL} to the high voltage potential V_{GH}.

In the duration from time t2 to t3, the first, second and third transistors T1, T2 and T3 are turned off and the fourth transistor T4 is turned on. A₁ does not change and equals to V3.

From time t1 to t3, the fifth voltage signal VAC₁ is in its low voltage potential VcomL. However, at time t3, the AC voltage potential of the fifth voltage signal VAC₁ experiences a change the low voltage potential VcomL to the high voltage potential VcomH. Still, the first, second and third transistors T1, T2 and T3 are turned off and the fourth transistor T4 is turned on. Accordingly, A₁ experiences a voltage potential increase from V3 to V4. The voltage potential change, ΔV2=(V4−V3), at this time (t3), is considered as a second level lift-up of the coupling voltage potential A₁.

From time t3 to t4, the fifth voltage signal VAC₁ is in its high voltage potential VcomH, and the first, second and third transistors T1, T2 and T3 are turned off and the fourth transistor T4 is turned on. As a result, A₁ remains unchanged, which is equal to V4.

It is clear that due to the two-level lift-ups, the coupling voltage potential A1 is substantially increased or decreased. When applied to the storage capacitor Cst of each pixel of the first pixel row, it results a substantial increase or decrease of the voltage potential PE₁ at the pixel electrode of each pixel of the first pixel row, without increasing or decreasing the voltage potentials of the source data signal {dₘ}, thereby, reducing the power consumption of the data driver.

Similarly, the above discussion is also applicable to the coupling voltage potentials generated by other common voltage driving circuits.

Furthermore, according to the invention, as shown in FIG. 2, PE₁ and PE₂ are inverted to each other. As a result, the row inversion is achieved.

FIG. 3 shows time charts of driving signals applied to the LCD and corresponding pixel voltage potentials in the LCD according to another embodiment of the present invention. In this exemplary embodiment, VDC=1.5V, VDC1₁=3.0V, VDC2₁=1.0V, VDC1₂=1.0V, VDC2₂=3.0V, VcomL=1.0V, VcomH=3.0V. At t1, g₁ is changed to its high level, V_{GH}, and SWC1 is changed to its low level, V_{GL}, the first, second and third transistors T1, T2 and T3 are turned on and the fourth transistor T4 is turned off, A1 is changed from −2.5V to 1.5V. Then, in the duration of t2−t1, g₁ is hold in V_{GH}, and SWC1 is hold in V_{GL}, A1 is hold in 1.5V. At t2, g1 is changed to low level, V_{GL}, and SWC1 is changed to its high level, V_{GH}, the first, second and third transistors T1, T2 and T3 are turned off and the fourth transistor T4 is turned on, A1 is lifted-up to 3.5V because there are 2V between the two terminals of the capacitor C2 when the third transistor T3 is turned on (ΔV1=3.5V−1V). In the duration of t3−t2, g₁ is hold in V_{GL}, and SWC₁ is hold in V_{GH}, A1 is hold in 3.5V. At t3, g₁ is hold in V_{GL}, SWC₁ is hold in V_{GH}, and VAC1 is changed from VcomL to VcomH, the first, second and third transistors T1, T2 and T3 is turned off and the fourth transistor T4 is turned on, and A1 is lifted-up to 5.5V (ΔV2=3V−1V) because of the variation of VAC1. Accordingly, the first lift-up voltage is about 2V and the second lift-up voltage is about 2V, i.e., the total two level lift up of the coupling voltage potential is about (ΔV1+ΔV2)=4.0V.

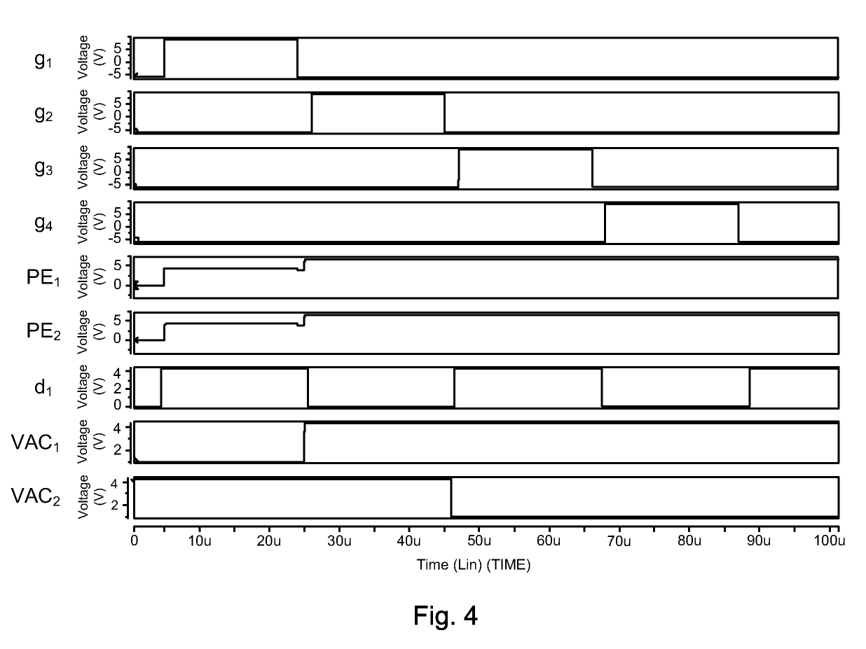

FIG. 4 shows an HSpice simulation for a TMD DCcom row inversion on a matrix of 6×8 pixels, with voltage settings: for the gate signals: V_{GH}=9.0V, V_{GL}=−6.0V, for the source signals: V_{SH}=4.3V, V_{SL}=0.0V, for the fifth voltage signal VACₙ: VcomH=2.7V, VcomL=1.0V, the first voltage signal VDC=1.81V. The simulation result is LC difference voltage: 4.837V (white) and 0.476V (black), and RMS power: 4.975 μW (white, 2 frames).

As a comparison, an HSpice simulation for a traditional row inversion on a matrix of 6×8 pixels is also conducted, with voltage settings: for the gate signals: V_{GH}=9.0V, V_{GL}=−6.0V, for the source signals: V_{SH}=5.0V, V_{SL}=0.0V, for the fifth voltage signal VACₙ: VcomH=5.0V, VcomL=0.0V. The simulation result is LC difference voltage: 4.639V and RMS power: 21.78 μW. It is clear that the traditional row inversion LCD consumes more power than the TMD DCcom row inversion LCD does.

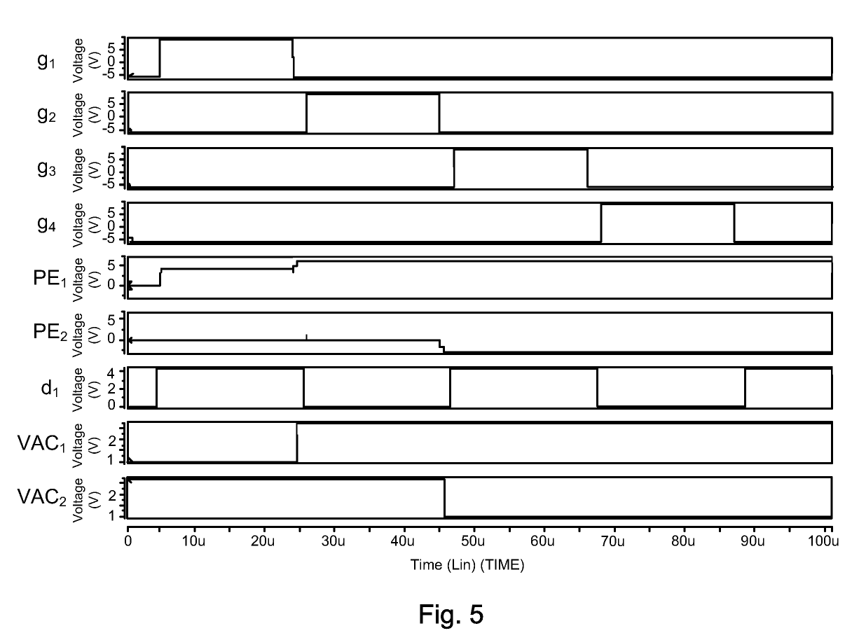

FIG. 5 shows an HSpice simulation for a two-level lift-up row inversion on a matrix of 6×8 pixels, with voltage settings: for the gate signals: V_{GH}=9.0V, V_{GL}=−6.0V, for the source signals: V_{SH}=4.3V, V_{SL}=0.0V, for the fifth voltage signal VACₙ: VcomH=2.7V, VcomL=1.0V, the first voltage signal VDC=1.81V. The simulation result is LC difference voltage: 4.837V (white) and 0.517V (black), and RMS power: 3.748 μW (white, 2 frames). Comparing to the traditional row inversion LCD and the TMD DCcom row inversion LCD, the two-level lift-up row inversion LCD consumes much less power.

Another aspect of the present invention provides a method of driving the LCD disclosed in FIG. 1. In one embodiment, the method includes the following steps: at first, a plurality of common voltage driving circuits {CTₙ} is provided. Each common voltage driving circuit CTₙ, electrically coupled between the scanning line Gₙ and the corresponding auxiliary common electrode ACEₙ. Then, a plurality of scanning signals {gₙ} and a plurality of data signals {dₘ} are respectively applied to the plurality of scanning lines {Gₙ} and the plurality of data lines {Dₘ}. The plurality of scanning signals {gₙ} is configured to turn on the transistors T0 (switching element) connected to the plurality of scanning lines {Gₙ} in a predefined sequence. Meanwhile, a plurality of common voltage driving signals is applied to the plurality of common voltage driving circuits {CTₙ} so as to responsively generate a plurality of two-level lift-up coupling voltages. Each two-level lift-up coupling voltage is applied to the auxiliary common electrode ACEₙ of a corresponding pixel row. Each common voltage driving signal includes a set of a first voltage VDC, a second voltage VDC1ₙ, a third voltage VDC2ₙ, a fourth voltage SWCₙ, and a fifth voltage VACₙ.

Each of the first voltage VDC, the second voltage VDC1ₙ and the third voltage VDC2ₙ is a DC voltage, while ach of the fourth voltage SWCₙ and the fifth voltage VACₙ is an AC voltage. In one embodiment, VDC1ₙ=VDC2ₙ₊₁, and VDC2ₙ=VDC1ₙ₊₁, and wherein the fourth voltage SWCₙ is characterized a waveform that is complimentary to the waveform of a corresponding gate signal gₙ.

In sum, the present invention, among other things, recites an LCD that utilizes common voltage driving circuits to generate two level lift-up coupling voltages with each applied to the common electrode of the storage capacitor Cₛₜ of each pixel of a corresponding pixel rows so as to achieve the row inversion and reduce power consumption of the data driver and methods of driving same.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A liquid crystal display (LCD), comprising:
(a) a common electrode;
(b) a plurality of scanning lines, {Gₙ}, n=1, 2, . . . , N, N being an integer greater than zero, spatially arranged along a row direction;
(c) a plurality of data lines, {Dₘ}, m=1, 2, . . . , M, M being an integer greater than zero, spatially arranged crossing the plurality of scanning lines {Gₙ} along a column direction perpendicular to the row direction;
(d) a plurality of pixels, {P_{n,m}}, spatially arranged in the form of a matrix, each pixel row, defined between two neighboring scanning lines Gₙ and Gₙ₊₁, having an auxiliary common electrode ACEₙ, each pixel P_{n,m}, defined between two neighboring scanning lines Gₙ and Gₙ₊₁ and two neighboring data lines Dₘ and Dₘ₊₁, comprising:
(i) a pixel electrode;
(ii) a transistor, T0, having a gate, a source and a drain electrically coupled to the scanning line Gₙ, the data line Dₘ and the pixel electrode, respectively;
(iii) a liquid crystal capacitor, Clc, electrically coupled between the pixel electrode and the common electrode; and
(iv) a charge storage capacitor, Cst, electrically coupled between the pixel electrode and the auxiliary common electrode ACEₙ, and
(e) a plurality of common voltage driving circuits {CTₙ}, each common voltage driving circuit CTₙ, electrically coupled between the scanning line Gₙ and the corresponding auxiliary common electrode ACEₙ, comprising:
a first transistor, T1, a second transistor, T2, a third transistor, T3, and a fourth transistor, T4, each transistor having a gate, a source and a drain, wherein the gate of each of the first transistor T1, the second transistor T2 and the third transistor T3 is electrically coupled to the gate scanning line Gₙ, and the gate of the fourth transistor T4 is electrically coupled to a fourth voltage, SWCₙ, that is inverse to a corresponding scanning signal, gₙ to be applied to the gate scanning line Gₙ.

2. The LCD of claim 1, wherein each common voltage driving circuit CTₙ further comprises a first capacitor, C1, having a first terminal electrically coupled to the drain of the first transistor T1 and a second terminal electrically coupled to the drain of the second transistor T2 and a second capacitor, C2, having a first terminal electrically coupled to the drain of the third transistor T3 and a second terminal configured to receive a fifth voltage, VACₙ, wherein
(a) the source of the first transistor T1 is configured to receive a first voltage, VDC, and the drain of the first transistor T1 is electrically coupled to the auxiliary common electrode ACEₙ;
(b) the source of the second transistor T2 is configured to receive a second voltage, VDC1ₙ;
(c) the source of the third transistor T3 is configured to receive a third voltage, VDC2ₙ; and
(d) the source of the fourth transistor T4 is electrically coupled to the drain of the third transistor T3, and the drain of the fourth transistor T4 is electrically coupled to the drain of the second transistor T2.

3. The LCD of claim 1, further comprising:
(a)e a gate driver for generating a plurality of scanning signals, {gₙ}, respectively applied to the plurality of scanning lines {Gₙ}, wherein the plurality of scanning signals {gₙ} is configured to turn on the transistors T0 connected to the plurality of scanning lines {Gₙ} in a predefined sequence; and
(b) a data driver for generating a plurality of data signals, {dₘ}, respectively applied to the plurality of data lines {Dₘ}.

4. The LCD of claim 3, wherein each of the plurality of scanning signals {gₙ} is configured to have a waveform having a first voltage potential, V_{GH}, and a second voltage potential, V_{GL}, wherein V_{GH}>V_{GL}, and wherein the waveform of each scanning signal gₙ is sequentially shifted from one another.

5. The LCD of claim 4, wherein each of the first voltage VDC, the second voltage VDC1ₙ and the third voltage VDC2ₙ is a DC voltage, and wherein each of the fourth voltage SWCₙ and the fifth voltage VACₙ is an AC voltage.

6. The LCD of claim 5, wherein VDC1ₙ=VDC2ₙ₊₁, and VDC2₁=VDC1ₙ₊₁, and wherein the fourth voltage SWCₙ is characterized with a waveform that is complimentary to the waveform of a corresponding gate signal gₙ.

7. The LCD of claim 6, wherein, in operation, the plurality of pixels {P_{n,m}} has a pixel polarity that is in the row inversion.

8. The LCD of claim 1, further comprising a panel having an active area for display and a non-active area adjacent to the active area, wherein the plurality of pixels, {P_{n,m}} is formed in the active area of the panel, and wherein the plurality of common voltage driving circuits {CTₙ} is formed in the non-active area of the panel.

9. A liquid crystal display (LCD) having a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, comprising:
(a) a common electrode;
(b) a plurality of pixels, {P_{n,m}}, spatially arranged in the form of a matrix having N pixel rows and M pixel columns, each pixel row, defined between two neighboring scanning lines Gₙ and Gₙ₋₁ having an auxiliary common electrode ACEₙ, each pixel P_{n,m}, defined between two neighboring scanning lines Gₙ and Gₙ₊₁ and two neighboring data lines Dₘ and Dₘ₊₁, comprising:
(i) a pixel electrode;
(ii) a transistor, T0, having a gate, a source and a drain electrically coupled to the scanning line Gₙ, the data line Dₘ and the pixel electrode, respectively;
(iii) a liquid crystal capacitor, Clc, electrically coupled between the pixel electrode and the common electrode 130; and
(iv) a charge storage capacitor, Cst, electrically coupled between the pixel electrode and the auxiliary common electrode ACEₙ; and
(c) a plurality of common voltage driving circuits {CTₙ}, each common voltage driving circuit CTₙ, electrically coupled between the scanning line Gₙ and the corresponding auxiliary common electrode ACEₙ for providing a two-level lift-up coupling voltage to the auxiliary common electrode ACEₙ.

10. The LCD of claim 9, wherein each common voltage driving circuit CTₙ comprises:
(a) a first transistor, T1, having a gate electrically coupled to the scanning line Gₙ, a source configured to receive a first voltage, VDC, and a drain electrically coupled to the auxiliary common electrode ACEₙ;
(b) a second transistor, T2, having a gate electrically coupled to the scanning line Gₙ, a source configured to receive a second voltage, VDC1ₙ, and a drain;
(c) a third transistor, T3, having a gate electrically coupled to the scanning line Gₙ, a source configured to receive a third voltage, VDC2ₙ, and a drain;
(d) a fourth transistor, T4, having a gate configured to receive a fourth voltage, SWCₙ, a source electrically coupled to the drain of the third transistor T3, and a drain electrically coupled to the drain of the second transistor T2;
(e) a first capacitor, C1, having a first terminal electrically coupled to the drain of the first transistor T1 and a second terminal electrically coupled to the drain of the second transistor T2; and
(f) a second capacitor, C2, having a first terminal electrically coupled to the drain of the third transistor T3 and a second terminal configured to receive a fifth voltage, VACₙ.

11. The LCD of claim 10, further comprising:
(a) a gate driver for generating a plurality of scanning signals, {gₙ}, respectively applied to the plurality of scanning lines {Gₙ}, wherein the plurality of scanning signals {gₙ} is configured to turn on the transistors T0 connected to the plurality of scanning lines {Gₙ} in a predefined sequence; and
(b) a data driver for generating a plurality of data signals, {dₘ}, respectively applied to the plurality of data lines {Dₘ}.

12. The LCD of claim 11, wherein each of the plurality of scanning signals {gₙ} is configured to have a waveform having a first voltage potential, V_{GH}, and a second voltage potential, V_{GL}, wherein V_{GH}>V_{GL}, and wherein the waveform of each scanning signal gₙ is sequentially shifted from one another.

13. The LCD of claim 12, wherein each of the first voltage VDC, the second voltage VDC1ₙ and the third voltage VDC2ₙ is a DC voltage, and wherein each of the fourth voltage SWCₙ and the fifth voltage VACₙ is an AC voltage.

14. The LCD of claim 13, wherein VDC1ₙ=VDC2ₙ₊₁, and VDC2ₙ=VDC1ₙ₊₁, and wherein the fourth voltage SWCₙ is characterized with a waveform that is complimentary to the waveform of a corresponding gate signal gₙ.

15. The LCD of claim 9, further comprising a panel having an active area for display and a non-active area adjacent to the active area, wherein the plurality of pixels, {P_{n,m}} is formed in the active area of the panel, and wherein the plurality of common voltage driving circuits {CTₙ} is formed in the non-active area of the panel.

16. A method of driving a liquid crystal display (LCD) having a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, and a plurality of pixels, {P_{n,m}}, spatially arranged in the form of a matrix having N pixel rows and M pixel columns, each pixel row, defined between two neighboring scanning lines Gₙ and G₊₁, having an auxiliary common electrode ACEₙ, each pixel P_{n,m}, defined between two neighboring scanning lines Gₙ and Gₙ₊₁ and two neighboring data lines Dₘ and Dₘ₊₁, comprising a pixel electrode, a common electrode, a transistor, T0, having a gate, a source and a drain electrically coupled to the scanning line Gₙ, the data line Dₘ and the pixel electrode, respectively, a liquid crystal capacitor, Clc, electrically coupled between the pixel electrode and the common electrode, and a charge storage capacitor, Cst, electrically coupled between the pixel electrode and the auxiliary common electrode ACEₙ; comprising the steps of:
(a) providing a plurality of common voltage driving circuits {CTₙ}, each common voltage driving circuit CTₙ, electrically coupled between the scanning line Gₙ and the corresponding auxiliary common electrode ACEₙ;
(b) applying a plurality of scanning signals, {gₙ}, to the plurality of scanning lines {Gₙ} and a plurality of data signals, {dₘ}, to the plurality of data lines {Dₘ}, respectively, the plurality of scanning signals {gₙ} configured to turn on the transistors T0 connected to the plurality of scanning lines {Gₙ} in a predefined sequence; and
(c) applying a plurality of common voltage driving signals to the plurality of common voltage driving circuits {CTₙ} so as to responsively generate a plurality of two-level lift-up coupling voltages, each two-level lift-up coupling voltage applied to the auxiliary common electrode ACEₙ of a corresponding pixel row.

17. The method of claim 16, wherein each common voltage driving signal comprises a set of a first voltage, VDC, a second voltage, VDC1ₙ, a third voltage, VDC2ₙ, a fourth voltage, SWCₙ, and a fifth voltage, VACₙ.

18. The method of claim 17, wherein each common voltage driving circuit comprises:
(a) a first transistor, T1, having a gate electrically coupled to the scanning line Gₙ, a source configured to receive the first voltage VDC, and a drain electrically coupled to the auxiliary common electrode ACEₙ;
(b) a second transistor, T2, having a gate electrically coupled to the scanning line Gₙ, a source configured to receive the second voltage VDC1ₙ, and a drain;
(c) a third transistor, T3, having a gate electrically coupled to the scanning line Gₙ, a source configured to receive the third voltage VDC2ₙ, and a drain;
(d) a fourth transistor, T4, having a gate configured to receive the fourth voltage, SWCₙ, a source electrically coupled to the drain of the third transistor T3, and a drain electrically coupled to the drain of the second transistor T2;
(e) a first capacitor, C1, having a first terminal electrically coupled to the drain of the first transistor T1 and a second terminal electrically coupled to the drain of the second transistor T2; and
(f) a second capacitor, C2, having a first terminal electrically coupled to the drain of the third transistor T3 and a second terminal configured to receive the fifth voltage, VACₙ.

19. The method of claim 18, wherein each of the first voltage VDC, the second voltage VDC1ₙ and the third voltage VDC2ₙ is a DC voltage, and wherein each of the fourth voltage SWCₙ and the fifth voltage VACₙ is an AC voltage.

20. The method of claim 19, wherein VDC1ₙ=VDC2ₙ₊₁, and VDC2ₙ=VDC1ₙ₊₁, and wherein the fourth voltage SWCₙ is configured to have a waveform that is complimentary to a waveform of a corresponding gate signal gₙ.

21. The method of claim 20, wherein, in operation, the plurality of pixels {P_{n,m}} has a pixel polarity that is in the row inversion.

22. A common voltage driving circuit for a liquid crystal display (LCD) having a plurality of scanning lines, {Gₙ}, spatially arranged along a row direction, and a plurality of data lines, {Dₘ}, spatially arranged crossing the plurality of scanning lines {Gₙ} along a column direction perpendicular to the row direction, n=1, 2, . . . , N, m=1, 2, . . . , M, and N, M being an integer greater than zero, and a plurality of pixels, {P_{n,m}}, spatially arranged in the form of a matrix having N pixel rows and M pixel columns, each pixel row, defined between two neighboring scanning lines Gₙ and Gₙ₊₁, having an auxiliary common electrode ACEₙ, comprising:
(a) a first transistor, T1, having a gate electrically coupled to the scanning line Gₙ, a source configured to receive a first voltage, VDC, and a drain electrically coupled to the auxiliary common electrode ACEₙ;
(b) a second transistor, T2, having a gate electrically coupled to the scanning line Gₙ, a source configured to receive a second voltage, VDC1ₙ, and a drain;
(c) a third transistor, T3, having a gate electrically coupled to the scanning line Gₙ, a source configured to receive a third voltage, VDC2ₙ, and a drain;
(d) a fourth transistor, T4, having a gate configured to receive a fourth voltage, SWCₙ, a source electrically coupled to the drain of the third transistor T3, and a drain electrically coupled to the drain of the second transistor T2;
(e) a first capacitor, C1, having a first terminal electrically coupled to the drain of the first transistor T1 and a second terminal electrically coupled to the drain of the second transistor T2; and
(f) a second capacitor, C2, having a first terminal electrically coupled to the drain of the third transistor T3 and a second terminal configured to receive a fifth voltage, VACₙ.

23. The common voltage driving circuit of claim 22, wherein each of the first voltage VDC, the second voltage VDC1ₙ and the third voltage VDC2ₙ is a DC voltage, and wherein each of the fourth voltage SWCₙ and the fifth voltage VACₙ is an AC voltage.
